(19) United States
(12) Patent Application Publication
(10) Pub. No.: US 2021/0065187 A1
(43) Pub. Date: Mar. 4, 2021

(54) COMPUTER-IMPLEMENTED METHOD FOR DETECTING FRAUDULENT TRANSACTIONS BY USING AN ENHANCED K-MEANS CLUSTERING ALGORITHM

(71) Applicant: COUPANG CORP., Seoul (KR)

(72) Inventor: Xiaojun HUANG, Shanghai (CN)

(73) Assignee: Coupang Corp.

(21) Appl. No.: 16/553,099

(22) Filed: Aug. 27, 2019

(51) Int. Cl. G06Q 20/40; G06F 16/28; G06F 16/23

(52) U.S. Cl. CPC G06Q 20/4016; G06F 16/2365; G06F 16/2379; G06F 16/285

(57) ABSTRACT

Methods and systems for detecting fraudulent data points in a database of a computerized system include receiving, from a user interface, a request for detecting one or more fraudulent data points, choosing minimum and maximum values of k for use in clustering the data points in the database, k being a cluster number; and generating empty outlier scores corresponding to the data points. The methods and systems further include executing, starting with the minimum value of k, functions in an iterative or recursive manner, until the maximum value of k is reached. The functions include choosing k random points as centroids, performing k-means clustering on the chosen centroids, and computing a temporary outlier score for each of the data points in an iterative or recursive manner until a total number of data points is reached. The functions further include updating the outlier scores by adding the temporary outlier scores to the corresponding outlier scores and storing the updated outlier scores. When the maximum value of k is reached, the methods and systems further include normalizing the stored outlier scores and detecting a fraudulent data point based on the normalized outlier scores that indicate consistent degrees.

### TECHNICAL FIELD

The present disclosure generally relates to computerized systems and methods for detecting fraudulent data points in a database of such a system. Embodiments of the present disclosure relate to inventive and unconventional systems for detecting fraudulent data points, such as fraudulent transactions, by using an enhanced k-means clustering algorithms on a such system.

### BACKGROUND

With the proliferation of the Internet, more and more users are using the internet to purchase goods. As the scope and volume of electronic transactions continues to grow, systems and methods were developed to detect fraudulent transactions. However, fraudulent transactions evolved as the detection methods and systems developed. The fraudulent transactions shifted in different forms exhibiting totally different patterns.

Conventional methods and systems emphasize on detecting an anomaly among non-anomalies by using static rules. The systems first identify at least one anomaly and then write rules to detect the anomaly. The rules may be identified using pattern mining techniques. Assumptions on the static rules are that most anomalies belong to few anomaly types, thus the systems may detect most anomalies by finding few static rules that describe those anomaly types. However, the static rules may not detect anomalies that exhibit different patterns to evade the rules.

Therefore, there is a need for improved methods and systems for detecting a fraudulent data point in electronic transactions.

### SUMMARY

One aspect of the present disclosure is directed to a system including a memory storing instructions and at least one processor programmed to execute the instructions to perform a method for detecting a fraudulent data point using an enhanced k-means clustering algorithm. The method includes receiving, from a user device, a request for detecting one or more fraudulent data points, choosing minimum and maximum values of k for use in clustering the data points in the database, k being a cluster number, and generating empty outlier scores corresponding to the data points. The method further includes executing, starting with the minimum value of k, functions in an iterative or recursive manner, until the maximum value of k is reached. The functions include choosing k random points as centroids, performing k-means clustering on the chosen centroids, and computing a temporary outlier score for each of the data points in an iterative or recursive manner until a total number of data points is reached. The functions further include updating the outlier scores by adding the temporary outlier scores to the corresponding outlier scores and storing the updated outlier scores. When the maximum value of k is reached, the method further includes normalizing the stored outlier scores and detecting a fraudulent data point based on the normalized outlier scores that indicate consistent degrees.

Another aspect of the present disclosure is directed to a method for detecting a fraudulent data point using an enhanced k-means clustering algorithm. The method includes receiving, from a user device, a request for detecting one or more fraudulent data points, choosing minimum and maximum values of k for use in clustering the data points in the database, k being a cluster number, and generating empty outlier scores corresponding to the data points. The method further includes executing, starting with the minimum value of k, functions in an iterative or recursive manner, until the maximum value of k is reached. The functions include choosing k random points as centroids, performing k-means clustering on the chosen centroids, and computing a temporary outlier score for each of the data points in an iterative or recursive manner until a total number of data points is reached. The functions further include updating the outlier scores by adding the temporary outlier scores to the corresponding outlier scores and storing the updated outlier scores. When the maximum value of k is reached, the method further includes normalizing the stored outlier scores and detecting a fraudulent data point based on the normalized outlier scores that indicate consistent degrees.

Yet another aspect of the present disclosure is directed to a non-transitory computer-readable storage medium that comprises instructions that may be executed by a processor to perform a method for detecting a fraudulent data point using an enhanced k-means clustering algorithm. The method includes receiving, from a user device, a request for detecting one or more fraudulent data points, choosing minimum and maximum values of k for use in clustering the data points in the database, k being a cluster number, and generating empty outlier scores corresponding to the data points. The method further includes executing, starting with the minimum value of k, functions in an iterative or recursive manner, until the maximum value of k is reached. The functions include choosing k random points as centroids, performing k-means clustering on the chosen centroids, and computing a temporary outlier score for each of the data points in an iterative or recursive manner until a total number of data points is reached. The functions further include updating the outlier scores by adding the temporary outlier scores to the corresponding outlier scores and storing the updated outlier scores. When the maximum value of k is reached, the method further includes normalizing the stored outlier scores and detecting a fraudulent data point based on the normalized outlier scores that indicate consistent degrees.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 shows an exemplary method for detecting fraudulent data points using an enhanced k-means clustering algorithm on internal front end system, consistent with the disclosed embodiments.

FIGS. 4A, 4B, and 4C are sample transaction data points, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods, or by performing non-dependent steps in parallel with each other. Accordingly, the following detailed description is not limited to the disclosed embodiments and examples. Instead, the proper scope of the invention is defined by the appended claims.

Embodiments of the present disclosure are directed to computer-implemented systems and methods configured for detecting fraudulent data points by using an enhanced k-means clustering algorithm. The disclosed embodiments provide innovative technical features that allow users to detect a fraudulent data point by learning reliable behavior. Unlike fraudulent behaviors, a reliable behavior does not change over time. Thus, data points representing the reliable behavior have consistent spatial arrangements under different groupings. For example, the disclosed embodiments compute an outlier score for each data point representing consistency among the data points and detect a fraudulent data point by choosing a data point associated with an outlier score with inconsistent degrees.

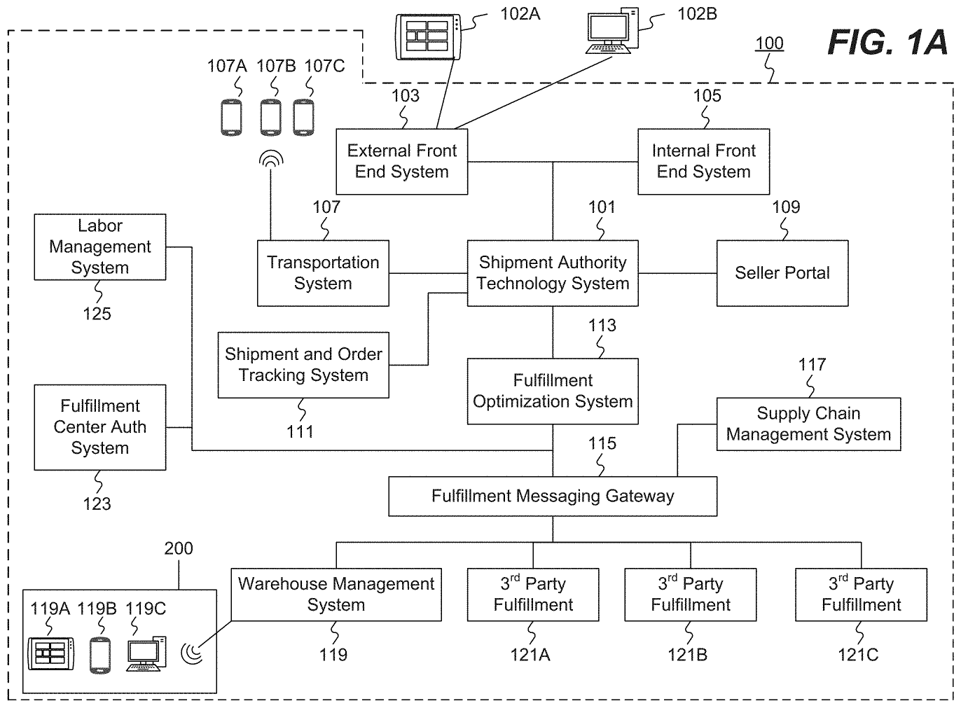

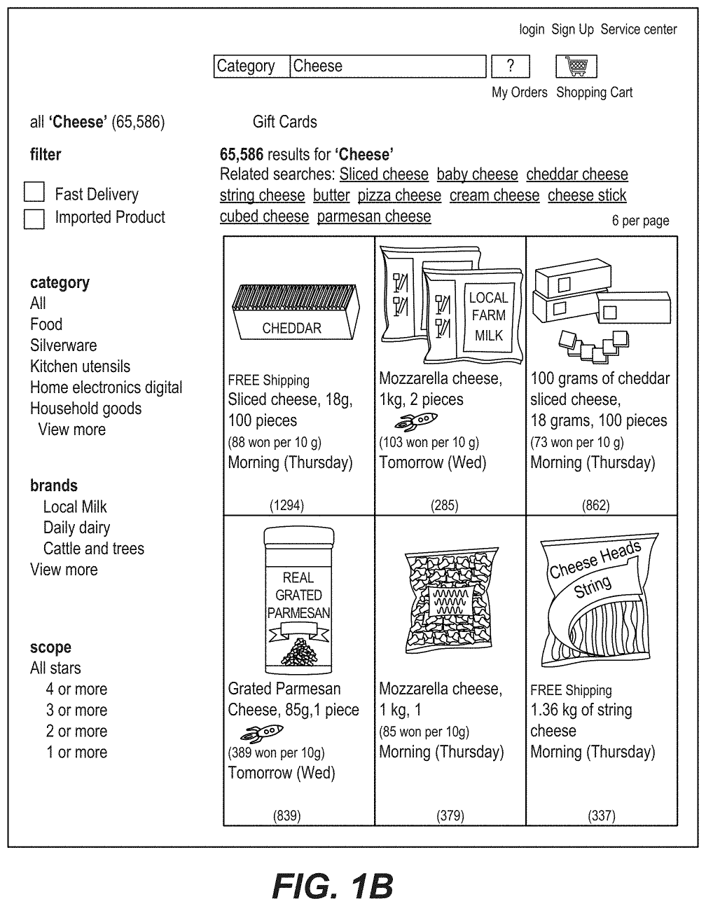

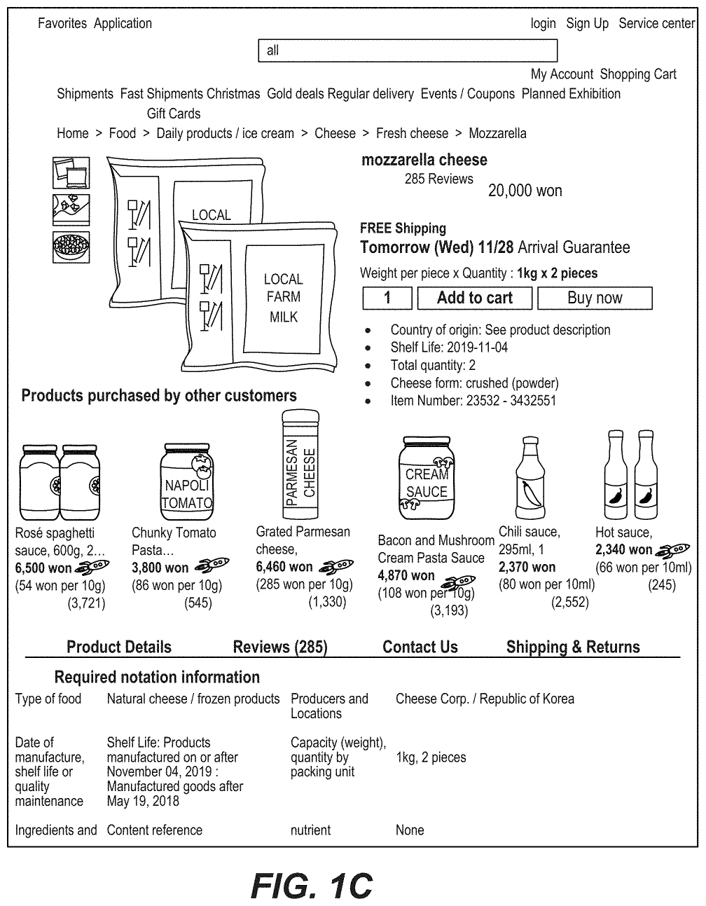

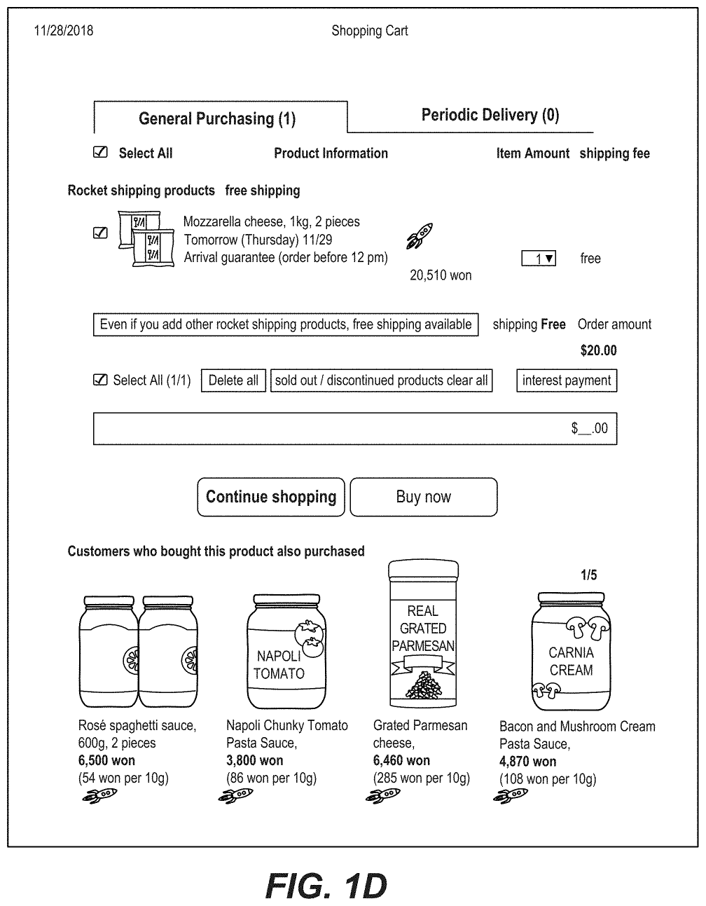

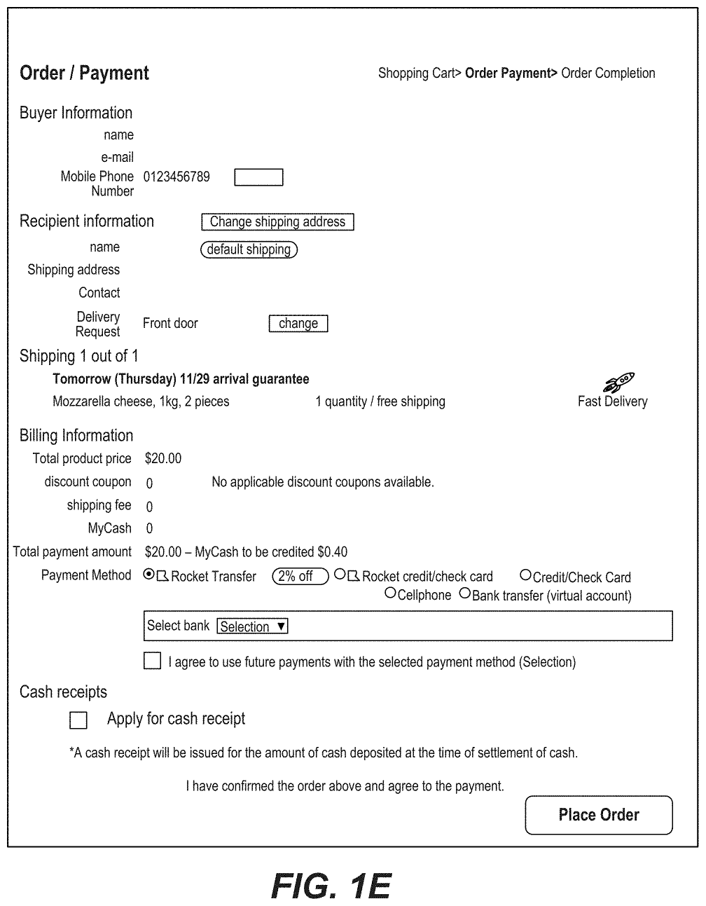

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

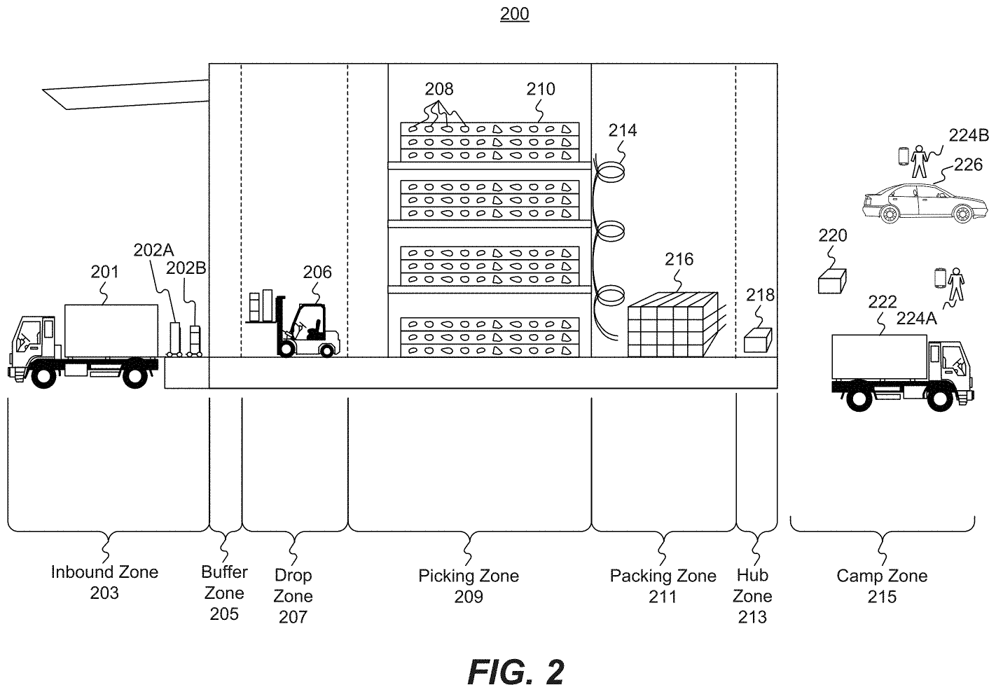

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1196, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

According to an aspect of the present disclosure, a computer-implemented system for detecting fraudulent data points using an enhanced k-means clustering algorithm may comprise one or more memory devices storing instructions, and one or more processors configured to execute the instructions to perform operations. The fraudulent data points may include, but not limited to, fraudulent payments, account takeovers, resales, and a buyer entity fraud. In some embodiments, the disclosed functionality and systems may be implemented as part of internal front end system 105. The preferred embodiment comprises implementing the disclosed functionality and systems on internal front end system 105, but one of ordinary skill will understand that other implementations are possible.

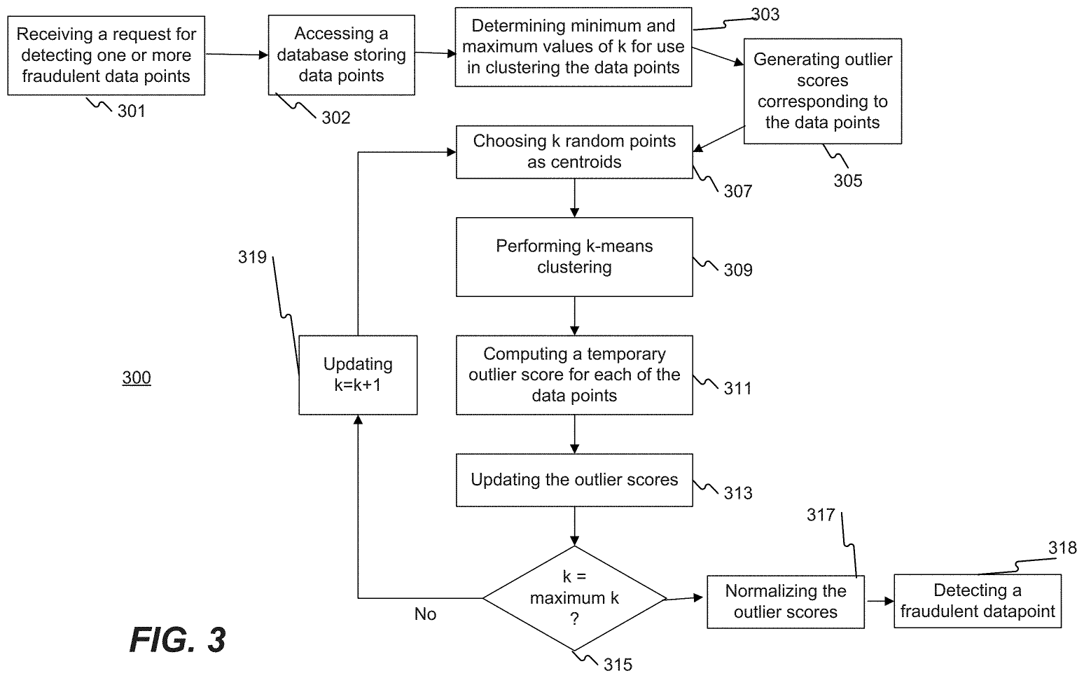

FIG. 3 shows an exemplary method 300 for detecting fraudulent data points using an enhanced k-means clustering algorithm on internal front end system 105. The method or a portion thereof may be performed by internal front end system 105. For example, the system may include one or more processors and a memory storing instructions that, when executed by the one or more processors, cause the system to perform the steps shown in FIG. 3.

In step 301, internal front end system 105 may receive a request for detecting one or more fraudulent data points from a user device (not pictured) associated with an internal user as internal front end system 105 may be implemented as a computer system that enables internal users (e.g., employees of an organization that owns, operates, or leases system 100) to interact with one or more systems in system 100 as discussed above with respect to FIG. 1A. For example, internal front end system 105 may receive a user input (e.g., from a button, keyboard, mouse, pen, touchscreen, or other pointing device) from a user device requesting detecting one or more fraudulent data points stored in a database (not pictured). Internal front end system 105, as discussed above with respect to FIG. 1A, may include one or more of a web caching system, a database, a search system, a payment system, an analytics system, an order monitoring system, or the like and store data points associated with transactions in the database. The user device may request detection of a fraudulent data point when a fixed time interval has passed or accumulated traffic flow has exceeded a predefined threshold to collect sufficient data points to identify patterns in the data points. For example, a data point may represent an electronic transaction, wherein the electronic transaction may include, but is not limited to, a merchant id, a transaction date, an average amount/transaction/day, a transaction amount, a type of transaction, a risk-level of transaction, and a daily chargeback average amount. Internal front end system 105 may modify the data points in the database by automatic audit system.

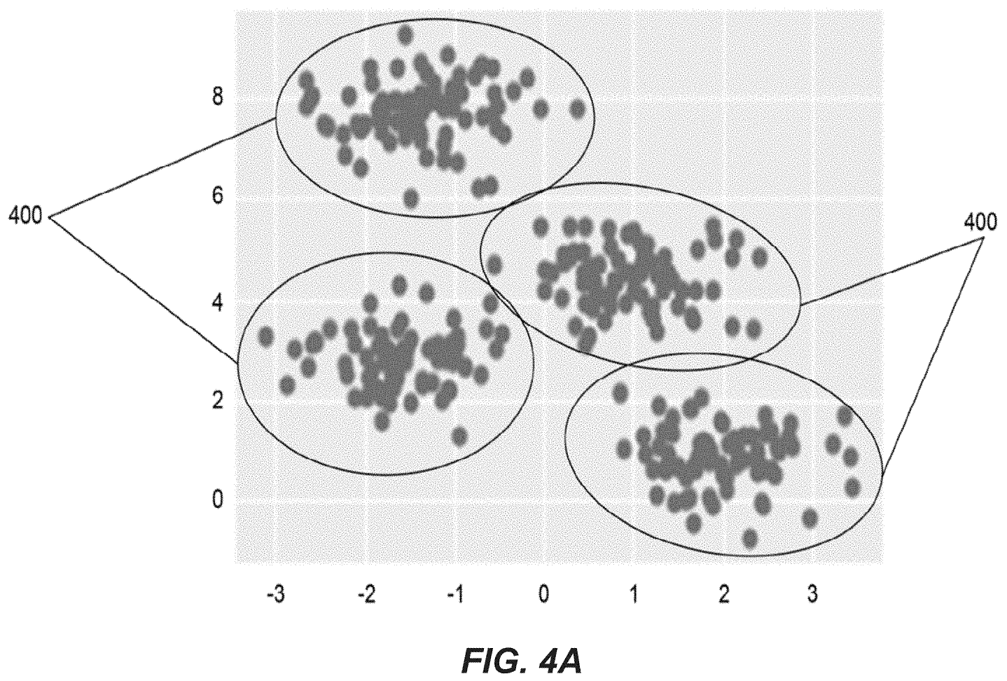

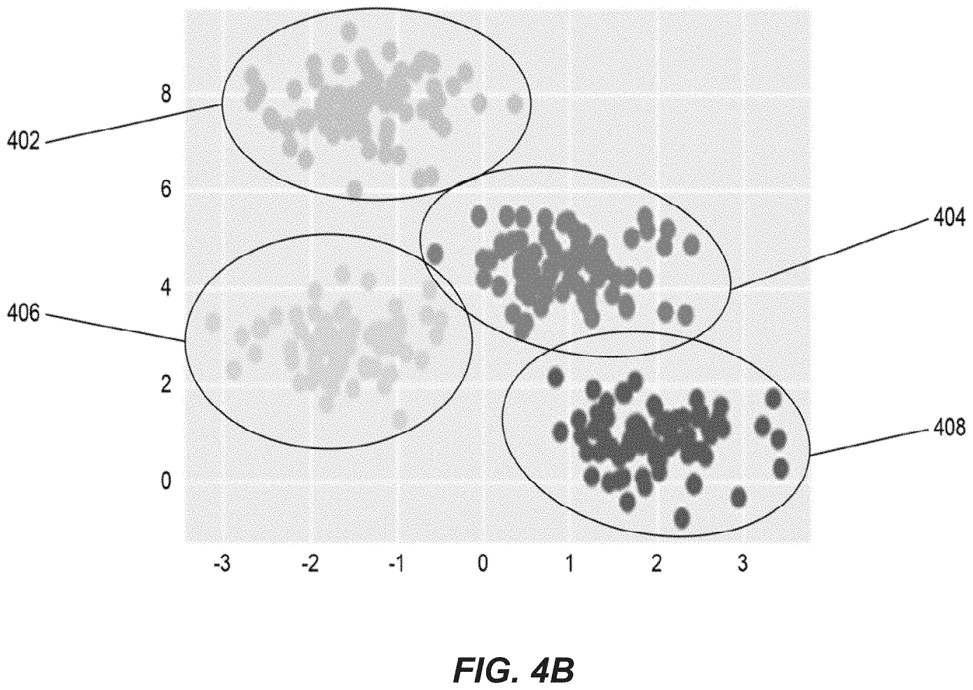

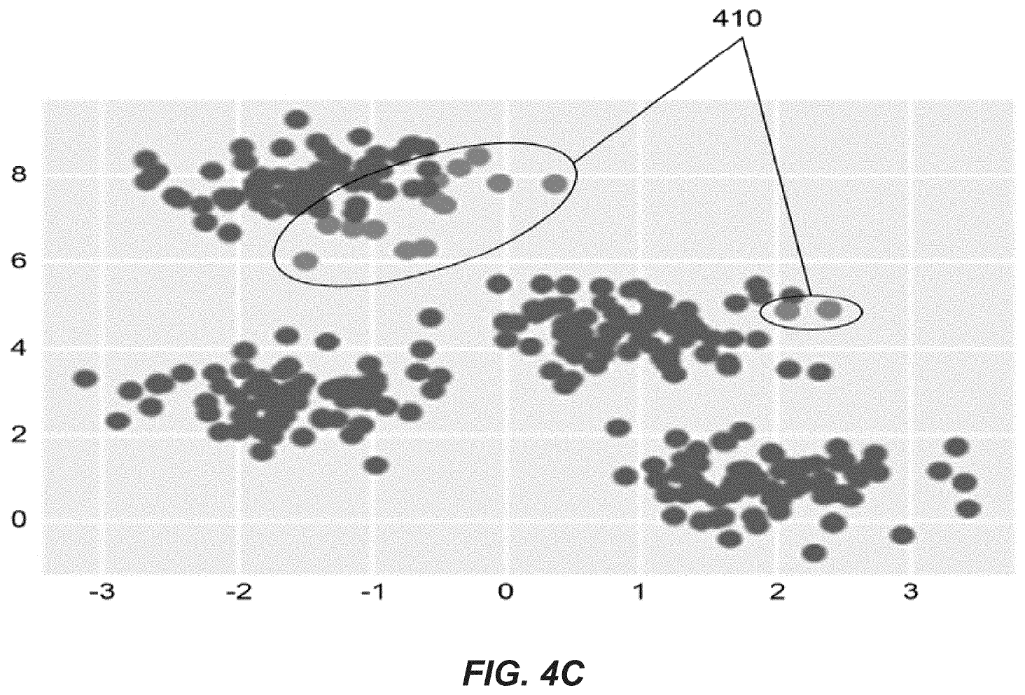

In step 302, internal front end system 105 may access the database storing data points. When internal front end system 105 accesses the database, it may extract attributes of data points. Attributes, also called features or variables, may characterize the data points. Based on the extracted attributes, internal front end system 105 may classify data points as either normal or abnormal. The attributes of data points may include, but not limited to, a merchant ID, a transaction date, an average amount per transaction or day, a transaction amount, a type of transaction, a risk level of transaction, and an average daily chargeback amount. Internal front end system 105 may scale the extracted attributes to numerical values because k-means clustering algorithm can only handle numerical values. As shown in FIG. 4A, two-dimensional data points 400 may be scattered in Cartesian coordinates. The data points are displayed as a collection of points, each having the value of one variable determining the position on the horizontal axis and the value of the other variable determining the position on the vertical axis. For example, the horizontal axis may represent one of the extracted and scaled attributes, a type of transaction, and the vertical axis may represent another extracted and scaled attribute, a transaction amount. While FIG. 4A is described with respect to two-dimensional data points 400, one of ordinary skill in the art will recognize that multi-dimensional data points may be used for detecting fraudulent data points.

The data points 400 may be retrieved from one or more databases kept by one or more systems. For example, the data points 400 may include data generated by, e.g., Fulfilment Optimization system 113 in association with fulfilling orders placed by a customer. The data may additionally or alternatively include data generated by, e.g., SAT system 101 in association with monitoring the order and delivery status of customer orders. In some embodiments, the transaction data may include a transaction ID that uniquely identifies each transaction in the system and some or all of the remaining data items may be retrieved from appropriate databases via one or more database queries based on the transaction ID.

In step 303, internal front end system 105 may determine minimum and maximum values of k (a cluster number) for use in clustering the data points. The minimum and maximum values of k may be chosen from 2 to a number of data points 400. The enhance k-means clustering algorithm may be performed for different values of k to find the right number of clusters (k) for clustering the data points.

In step 305, internal front end system 105 may generate outlier scores corresponding to the data points 400. For example, an initial outlier score for each data point is zero. The outlier scores may be updated as an enhanced k-means clustering algorithm is performed on the data points.

In steps 307 to 315, an enhanced k-means clustering algorithm is performed on the data points to determine fraudulent data points. For example, the following k-means clustering algorithm may be used:

| | |
|---|---|
| 01 | Require: = |
| 02 | Θ ← dataset with n data points |
| 03 | OutlierScore ← n dimensional array |
| 04 | N = a number of data points |
| 05 | for k = minimum k...maximum k |
| 06 | compute k-means clustering on Θ |
| 07 | for i = 1 ...n do |
| 08 | xᵢ~Θ = Set(n₁, n₂..n_{N}) //where nₖ is the number of data |
| | points in the cluster xᵢ belongs to |
| 09 | $OutlierScore ( i ) = \frac{{\sum }_{i = 1}^{N} \frac{{n}_{i}}{n}}{N}$ |
| 10 | End for |
| 11 | End for |

In step 307, internal front end system 105 may choose k random points as centroids. The cluster number k may be used in categorizing the data points in the database into k different clusters. Internal front end system 105 may randomly choose k samples (data points) from the data points as initial centroids because it does not know yet where the center of each cluster is.

In step 309, internal front end system 105 may perform k-means clustering. Internal front end system 105 may assign each data point to the closest centroid that would form a cluster. If internal front end system 105 uses the Cartesian distance (as depicted in FIGS. 4A-C) between data points and every centroid, a straight line is drawn between two centroids, then a perpendicular bisector (boundary line) divides this line into two clusters. After initial assignment, internal front end system 105 may update the centroids based on the data points assigned to each centroid. For example, internal front end system 105 may find the center of mass of the cluster by summing over all the data points in the cluster and dividing by the total number the data points. The center of mass may be assigned as new center (centroid) for the cluster. The system may repeat the assignment and updating the centroids for fixed number of iterations or until the centroids do not change. FIG. 4B depicts exemplary assignment for k=4 where each data point is assigned to one of the four different centroids and categorized into one of four different clusters 402, 404, 406, and 408.

In step 311, internal front end system 105 may compute a temporary outlier score for each of the data points. For example, internal front end system 105 may compute a temporary outlier score by

$$OutlierScore ( i ) = \frac{{\sum }_{i = 1}^{N} \frac{{n}_{i}}{n}}{N}$$

where i=each data point, N=a total number of data points, and nₖ=a number of data points in the cluster xᵢ belongs to.

In step 313, the system may update the outlier scores. The system may update the outlier scores for each data point by adding the corresponding temporary outlier scores from step 311. When k is equal to minimum value k, the outlier scores for each data point are zero because no outlier scores have been computed by an enhanced k-means clustering algorithm. However, as steps 307-315 are iterated until reaching maximum value k, the outlier scores for each data point will be updated by aggregating the temporary outlier scores from step 311.

In step 315, internal front end system 105 may determine whether the k is equal to maximum value k. If the k is not equal to maximum value k, the system, in step 319, may update the k by k=k+1. If the k is equal to maximum value k, the system, in step 317, may normalize the outlier scores. For example, the system may find a difference between maximum value k and minimum value k and divide the outlier scores by the difference.

Internal front end system 105 may perform various methods to normalize the outlier scores. A first method is using min-max normalization. Min-max normalization may retain an original distribution of outlier scores except for a scaling factor and transform all the outlier scores into a common range from 0 to 1. A second method is using standardization (Z-score normalization). Standardization is calculated using an arithmetic mean and standard deviation of the outlier scores. A third method is using median absolute deviation (MAD). MAD may normalize the outlier scores by subtracting the median of the outlier scores from each outlier score and dividing the result by median absolute deviation. After MAD normalization, each outlier score is shifted by the pre-normalization outlier scores mean and re-scaled by the pre-normalization sample median absolute deviation. A fourth method is Tanh-estimators. The results of Tanh-estimators normalization technique are similar to the results produced by the Z-score normalization but it assumes that a genuine score distribution in the transformed domain has a mean of 0.5 and a standard deviation of approximately 0.01.

In step 318, internal front end system 105 may detect a fraudulent data point based on the normalized outlier scores. The normalized outlier scores may indicate whether a data point is fraudulent if the normalized score of one data point falls below a predefined degree of consistency. Exemplary fraudulent data points are shown in FIG. 4C. As shown in FIG. 4C, for example, the system may determine fraudulent data points 410 when one more normalized outlier scores of data points fall below bottom 95 percent.

In some embodiments, internal front end system 105, after detecting the fraudulent data point, may blacklist a buyer/seller associated with an electronic transaction associated with the detected fraudulent data point. In some embodiments, the blacklisted buyer/seller may not make any electronic transactions until internal front end system 105 delist the blacklisted buyer/seller from the blacklist.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system comprising:
one or more memory devices storing instructions;
one or more processors configured to execute the instructions to perform operations comprising:
receiving, from a user device, a request for detecting one or more fraudulent data points related to one or more customers, the data points comprising one or more attributes associated with an electronic transaction;
accessing a database storing the data points to extract the one or more attributes and scale the extracted attributes to numerical values;
choosing minimum and maximum values of k for use in clustering the data points in the database, k being a cluster number;
generating empty outlier scores corresponding to the data points;
executing, starting with the minimum value of k, functions in an iterative or recursive manner, until the maximum value of k is reached, wherein the functions comprise:
choosing k random points as centroids;
performing k-means clustering on the chosen centroids;
computing a temporary outlier score for each of the data points including the extracted and scaled attributes in an iterative or recursive manner until a total number of data points is reached;
updating the outlier scores by adding the temporary outlier scores to the corresponding outlier scores; and
storing the updated outlier scores;
normalizing the stored outlier scores;
detecting a fraudulent data point based on the normalized outlier scores that indicate consistent degrees; and
blacklisting the one or more customer related to the detected fraudulent data point.

2. The computer-implemented system of claim 1, wherein computing k-means clustering comprises:
assigning each of the data points to nearest cluster by calculating its distance to each centroid; and
finding new cluster centers by taking the average of the assigned data points,
wherein the steps of assigning and finding are repeatedly performed until cluster assignments do not change.

3. The computer-implemented system of claim 1, wherein computing k-means clustering comprises:
assigning each of the data points to nearest cluster by calculating its distance to each centroid; and
finding new cluster centers by taking the average of the assigned data points,
wherein the steps of assigning and finding are repeatedly performed for fixed number of iterations.

4. The computer-implemented of claim 1, wherein computing a temporary outlier score further comprises using a proportion of the number of data points in the cluster to the number of the whole data points.

5. The computer-implemented system of claim 1, wherein normalizing stored outlier scores further comprises dividing the stored outlier scores by a difference between the maximum value of k and the minimum value of k.

6. The computer-implemented system of claim 1, wherein the normalized outlier scores close to 1 indicate high consistency and the normalized outlier scores close to 0 indicate low consistency.

7. The computer-implemented system of claim 1, wherein the fraudulent data points include fraudulent payments, account takeovers, resales, and buyer entity fraud.

8. The computer-implemented system of claim 1, wherein the one or more attributes associated with electronic transaction comprise a merchant id, a transaction date, an average amount/transaction/day, a transaction amount, a type of transaction, a risk-level of transaction, and a daily chargeback average amount.

9. The computer-implemented system of claim 1, wherein the operations further comprise modifying the data points in the database by automatic audit system.

10. A computer-implemented method comprising:
receiving, from a user device, a request for detecting one or more fraudulent data points related to one or more customers, the data points comprising one or more attributes associated with an electronic transaction;
accessing a database storing the data points to extract the one or more attributes and scale the extracted attributes to numerical values;
choosing minimum and maximum values of k for use in clustering the data points in the database, k being a cluster number;
generating empty outlier scores corresponding to the data points;
executing, starting with the minimum value of k, functions in an iterative or recursive manner, until the maximum value of k is reached, wherein the functions comprise:
choosing k random points as centroids;
performing k-means clustering on the chosen centroids;
computing a temporary outlier score for each of the data points including the extracted and scaled attributes in an iterative or recursive manner until a total number of data points is reached;
updating the outlier scores by adding the temporary outlier scores to the corresponding outlier scores; and
storing the updated outlier scores;
normalizing the stored outlier scores;
detecting a fraudulent data point based on the normalized outlier scores that indicate consistent degrees; and
blacklisting the one or more customer related to the detected fraudulent data point.

11. The computer-implemented method of claim 10, wherein computing k-means clustering comprises:
assigning each of the data points to nearest cluster by calculating its distance to each centroid; and
finding new cluster centers by taking the average of the assigned data points,
wherein the steps of assigning and finding are repeatedly performed until cluster assignments do not change.

12. The computer-implemented method of claim 10, wherein computing k-means clustering comprises:
assigning each of the data points to nearest cluster by calculating its distance to each centroid; and
finding new cluster centers by taking the average of the assigned data points,
wherein the steps of assigning and finding are repeatedly performed for fixed number of iterations.

13. The computer-implemented of method 10, wherein computing a temporary outlier score further comprises using a proportion of the number of data points in the cluster to the number of the whole data points.

14. The computer-implemented method of claim 10, wherein normalizing stored outlier scores further comprises dividing the stored outlier scores by a difference between the maximum value of k and the minimum value of k.

15. The computer-implemented method of claim 10, wherein the normalized outlier scores close to 1 indicate high consistency and the normalized outlier scores close to 0 indicate low consistency.

16. The computer-implemented method of claim 10, wherein the fraudulent data points include fraudulent payments, account takeovers, resales, and buyer entity fraud.

17. The computer-implemented method of claim 10, wherein the one or more attributes associated with electronic transaction comprise a merchant id, a transaction date, an average amount/transaction/day, a transaction amount, a type of transaction, a risk-level of transaction, and a daily chargeback average amount.

18. The computer-implemented method of claim 10, wherein the operations further comprise modifying the data points in the database by automatic audit system.

19. A computer-implemented system comprising:
one or more memory devices storing instructions;
one or more processors configured to execute the instructions to perform operations comprising:
receiving, from a user device, a request for detecting one or more fraudulent data points related to a one or more customers, the data points comprising one or more attributes associated with an electronic transaction;
accessing one or more databases kept by one or more systems storing the data points to extract the one or more attributes and scale the extracted attributes to numerical values;
choosing minimum and maximum values of k for use in clustering the data points in the database, k being a cluster number;
generating empty outlier scores corresponding to the data points;
executing, starting with the minimum value of k, functions in an iterative or recursive manner, until the maximum value of k is reached, wherein the functions comprise:
choosing k random points as centroids;
performing k-means clustering on the chosen centroids;
computing a temporary outlier score for each of the data points including the extracted and scaled attributes in an iterative or recursive manner until a total number of data points is reached;
updating the outlier scores by adding the temporary outlier scores to the corresponding outlier scores; and
storing the updated outlier scores;
normalizing the stored outlier scores;
detecting a fraudulent data point based on the normalized outlier scores that indicate consistent degrees; and
blacklisting the one or more customer related to the detected fraudulent data point.

20. The computer-implemented system of claim 19, wherein the normalized outlier scores close to 1 indicate high consistency and the normalized outlier scores close to 0 indicate low consistency.
